(19) United States
(12) Patent Application Publication
(10) Pub. No.: US 2009/0013371 A1
(43) Pub. Date: Jan. 8, 2009

(54) Digital broadcasting receiving apparatus

(75) Inventor: Hiroaki Shibahara, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 12/216,443

(22) Filed: Jul. 3, 2008

(30) Foreign Application Priority Data
Jul. 6, 2007 (JP) 2007-178740

(51) Int. Cl. H04N 7/173

(52) U.S. Cl. 725/134

(57) ABSTRACT

A digital broadcasting receiving apparatus includes an operating unit with a channel up/down key, an EEPROM for storing a channel map in which a virtual channel and a physical channel are associated with each other, and a control unit for obtaining virtual channel information that is multiplexed with the physical channel that is currently received. When a tuning operation of the operating unit is performed, a comparing unit of the control unit compares the virtual channel information of the received physical channel with the channel map. If there is an unregistered virtual channel in the channel map, a registration control unit of the control unit registers the virtual channel in the channel map.

This application is based on Japanese Patent Application No. 2007-178740 filed on Jul. 6, 2007, and the contents of which are hereby incorporated by reference.

### BACKGROUND OF THE INVENTION

1. Field of the Invention

The present invention relates to a digital broadcasting receiving apparatus such as a liquid crystal television set. In particular, the present invention can be applied effectively to a digital broadcasting receiving apparatus for receiving ATSC broadcasting.

2. Description of Related Art

At present, ground wave television broadcasting is in a transition period from analog broadcasting to digital broadcasting, so digital broadcasting receiving apparatuses capable of receiving digital broadcasting are becoming rapidly widespread.

As to digital broadcasting, a broadcasting station broadcasts a plurality of broadcast programs by using one frequency band. This is performed by compressing and encoding pictures and sounds of the plurality of broadcast programs, performing a time-division multiplexing process on the signals, modulating the signals with a high frequency radio wave of a predetermined frequency band, and broadcasting the signals as broadcasting signals. In addition, electronic broadcast program information about broadcast programs and their broadcasting channels is delivered every predetermined period of time by the time-division multiplexing with pictures and sounds of the broadcast programs in digital broadcasting.

In digital broadcasting, a broadcasting signal of a predetermined frequency band including the multiplexed broadcasting signals of the plurality of broadcast programs is called a physical channel, and a broadcasting signal of each broadcast program to be multiplexed in the frequency band is called a virtual channel.

When a user selects a channel of a desired broadcast program by using a remote controller or the like, the digital broadcasting receiving apparatus receives the high frequency radio wave of the frequency band corresponding to the physical channel. Then, it demodulates the reception signal so as to obtain a signal in which the compressed and encoded pictures of sounds of the plurality of broadcast programs, the electronic broadcast program information and other signals are multiplexed by time-division. This signal is called a transport stream (TS) signal.

Next, the digital broadcasting receiving apparatus separates and extracts a picture signal and a sound signal of the digital broadcasting corresponding to the virtual channel from the TS signal, so that the picture signal and the sound signal are decoded to be signals in the state before the compression and encoding, which are output to a display unit. In addition, the digital broadcasting receiving apparatus also extracts the electronic broadcast program information from the TS signal.

In North America, broadcasting called ATSC (Advanced Television System Committee) broadcasting that is one type of digital broadcasting is broadcasted. The ATSC broadcasting uses physical channels in each of which multiplexed information including pictures and sound of a plurality of broadcast programs broadcasted by the physical channel and other various data about television broadcasting called PSIP (Program and System Information Protocol). Furthermore, the PSIP includes VCT (Virtual Channel Table) and EIT (Event Information Table).

The VCT is defined in the ATSC standard a-65c and includes information as shown in FIG. 6. The VCT includes information of a channel number of the broadcast program and a source id associated with virtual channels (a major number and a minor number) having one-to-one relationship about a currently broadcasting program. The EIT includes broadcast program information such as broadcast program name, start time and end time of the broadcast program, and the like, and a source id about a currently broadcasting program and broadcast programs to be broadcasted in the future.

As described above, the EIT includes the broadcast program information such as a broadcast program name, start time and end time of the broadcast program, and the like, but it does not include channel information of the broadcast program. In contrast, the VCT includes the channel information and the source id of the broadcast program, but it does not include the broadcast program information such as a broadcast program name, start time and end time of the broadcast program, and the like. Therefore, association of the program name of a broadcast program with the broadcasting time and the broadcasting channel is performed based on the source id that is included in each of the VCT and the EIT.

Here, most of digital broadcasting receiving apparatuses stores a so-called channel map in a storage unit, which is a list of channels that can be selected. Which information is included in the channel map, or when and how the channel map is generated is different depending on the manufacturers or the individual apparatuses. For instance, the following techniques are proposed.

JP-A-2002-247459 discloses a receiving apparatus including a receiving unit for receiving digital broadcasting, a tuning unit for changing a channel of the digital broadcasting to be received by the receiving unit, and an automatic memory unit for detecting whether or not a broadcast program is currently broadcasting for each channel while the tuning unit changes the channel so as to register channels of currently broadcasting programs in a channel map. The digital broadcasting transmits channel information indicating attributions of virtual channels multiplexed in the channel. The automatic memory unit obtains the channel information of the channel of the broadcast program that is currently broadcasting. If another channel is set in the channel information, the automatic memory unit registers it in the channel map without detecting whether the broadcast program is currently broadcasting.

JP-A-2004-364216 discloses a digital/analog broadcasting receiving set including a receiving unit for receiving picture information of a plurality of television broadcast program together with an ATSC broadcasting signal including VCT information indicating an association relationship between channels for broadcasting these television broadcast programs and source IDs assigned to these channels individually and EIT information indicating an association relationship between the broadcast program information and the source ID for each of the television broadcast programs, a decoder for reproducing a picture signal of the television broadcast program from the ATSC broadcasting signal received by the receiving unit so as to output the picture signal to a television monitor connected to the main apparatus and for extracting the VCT information and the EIT information, a channel map generating unit for generating a channel map storing information indicting whether or not each of the channels is currently broadcasting based on the extracted VCT information and EIT information, an operating unit for a user to select a desired channel using a channel up/down key, and a control unit for controlling a selecting action based on the user's operation with the channel up/down key. The digital/analog broadcasting receiving set further includes a channel increase/decrease schedule storage unit for analyzing a channel increase or decrease schedule based on the VCT information and the EIT information so as to store channel increase/decrease schedule information as a result of the analysis while the television broadcasting is received, and a channel map updating unit for updating the channel map based on the channel increase/decrease schedule information stored in the channel increase/decrease schedule storage unit at channel increase/decrease schedule time. When the control unit detects the operation of the channel up/down key of the operating unit, it selects a channel registered in the channel map at that time in accordance with a preset predetermined order. If the selected channel is not currently broadcasting, the fact is output to the television monitor. Then, the channel map is updated so as to select the next channel registered in the channel map.

JP-A-2002-344829 discloses a digital broadcasting signal receiving apparatus including an input unit for inputting a selection instruction and other instructions to the main apparatus, a receiving unit for responding to the selection instruction so as to receive encoded digital/analog broadcasting signal transmitted from a broadcasting station, a digital/analog decoding unit for decoding the digital/analog broadcasting signal received by the receiving unit and outputting the same to a display unit for displaying pictures connected to the main apparatus, a storage unit for storing broadcasting channel map information including broadcasting channel numbers including channel numbers to be used for a selection action and virtual channel numbers, an OSD output unit for making the display unit perform a predetermined on-screen display, and a control unit for controlling the individual units of the apparatus. The control unit has a function of searching whether or not a digital channel number exists in a channel map stored in the storage unit when the digital channel number is input from the input unit, a function of receiving the broadcasting corresponding to the digital channel number if it exists as a result of the search and for outputting a signal for the OSD display on the display unit indicating no signal if the digital channel number does not exist, a function of scanning the entire range of frequency band of the broadcasting signal with the receiving unit and the decoding unit if the digital channel number does not exist as the result of the search and if a user inputs a scan instruction, a function of receiving a broadcasting if a signal of the digital channel number exists as the result of the search and for informing the fact if a signal of the digital channel number does not exist, and a function of switching between an enabled state and a disabled state of the scan function.

JP-A-2007-67648 discloses a television broadcasting receiving apparatus including a receiving unit for receiving television broadcasting signals, an operating input unit having a plurality of channel selecting keys, and a storage unit for storing broadcasting channels of the television broadcasting signals received by the receiving unit in association with a channel selecting key of the operating input unit as a channel map. The television broadcasting receiving apparatus further includes a display unit for displaying the channel map in such a manner that a channel selecting key of the operating input unit corresponding to the broadcasting channel that cannot be received can be identified when the receiving unit performs additional search of broadcasting channels and for displaying an additional channel list of a broadcasting channel map received newly by the additional search, and a broadcasting channel selecting unit for selecting a broadcasting channel from the additional channel list, which is to be assigned to any one of the channel selecting keys displayed in a discriminating manner on the channel map.

JP-A-2007-60057 discloses a television broadcasting receiving apparatus including a receiving unit for receiving television broadcasting signals, an operating input unit having a plurality of channel selecting keys, and a storage unit for storing broadcasting channels of television broadcasting signals received by the receiving unit in association with channel selecting keys of the operating input unit as a first channel map. The television broadcasting receiving apparatus further includes a unit for identifying the channel selecting key of the operating input unit corresponding to a broadcasting channel that cannot be received by the first channel map upon additional search of broadcasting channels by the receiving unit, and a display unit for displaying a second channel map for assigning broadcasting channels received newly by the additional search. The display unit displays the identified channel selecting key in such a manner that the identified channel selecting key can be recognized as a channel selecting key that can be assigned to a broadcasting channel received newly by the additional search on the second channel map.

Furthermore, there is a conventional digital broadcasting receiving apparatus in which a desired channel can be selected by using the channel up/down key by tuning one by one channel. This function utilizes the channel map, and the channels are selected in an order of the channel numbers registered in the channel map each time when the channel up/down key is pressed. Therefore, channels that are not registered in the channel map cannot be selected by the channel up/down key. If there is a new channel that is not registered in the channel map, it is necessary to input the channel number directly with bad usability.

In order to register a new channel that can be received in the channel map, it is necessary to do automatic scan in which all the frequency bands are scanned in turn automatically so that receivable channels can be searched or to do any other operation as described in the above-mentioned patent documents. In other words, it is necessary for the user to do a certain operation for starting registration in the channel map other than the tuning operation.

### SUMMARY OF THE INVENTION

An object of the present invention is to provide a digital broadcasting receiving apparatus having a good usability, which enables automatic registration of a new channel in a channel map, if any, only by a normal tuning operation, and enables to select the new channel by a channel up/down key.

A digital broadcasting receiving apparatus according to an embodiment of the present invention includes an operating unit for performing a tuning operation, a storage unit for storing a channel map indicating an association between a virtual channel and a physical channel, and a control unit for obtaining virtual channel information multiplexed in the physical channel that is currently received. When the tuning operation of the operating unit is performed, the control unit compares the virtual channel information of the received physical channel with the channel map and registers a virtual channel in the channel map if the virtual channel is not registered yet in the channel map.

According to this structure, a new channel that is not registered yet in a channel map can be registered automatically only by a normal tuning operation.

### BRIEF DESCRIPTION OF THE DRAWINGS

FIG. 1 is a block diagram showing a structure of a digital broadcasting receiving apparatus according to the present invention.

FIG. 2 is a flowchart showing an operation of the digital broadcasting receiving apparatus of the present invention about an automatic adding function.

FIG. 3 illustrates an example of a channel map according to the present invention.

FIG. 4 illustrates an example of a channel map according to the present invention.

FIG. 5 illustrates an example of a channel map according to the present invention.

FIG. 6 illustrates an example of VCT.

### DETAILED DESCRIPTION OF THE PREFERRED EMBODIMENTS

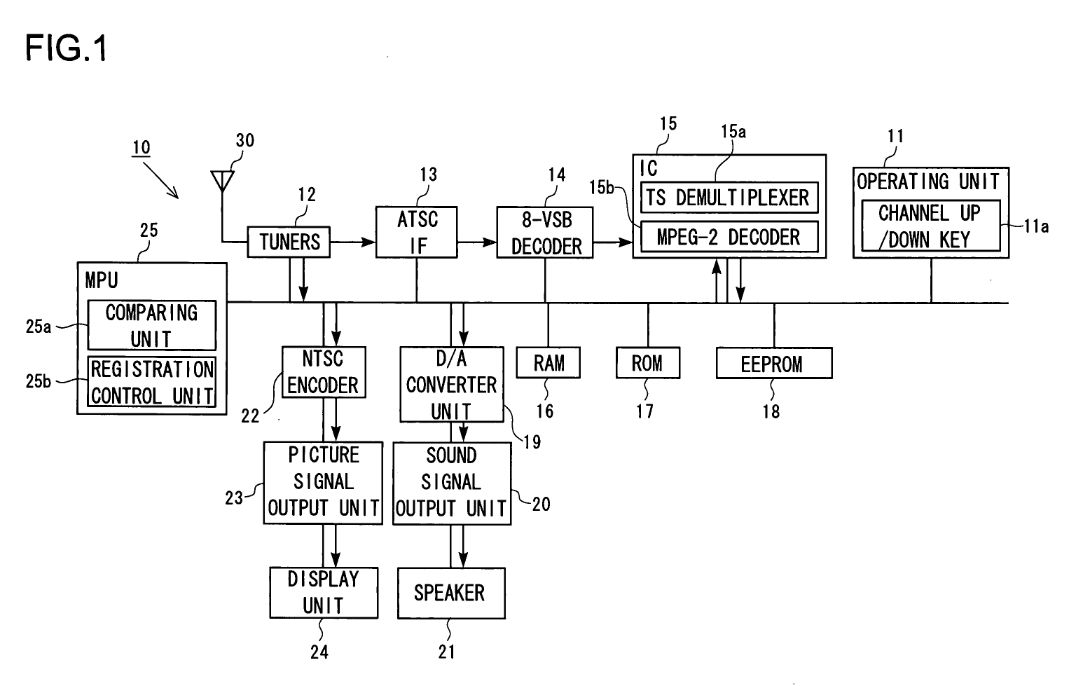

Hereinafter, a digital broadcasting receiving apparatus of ATSC standard will be described as an example. FIG. 1 is a block diagram showing a structure of a digital broadcasting receiving apparatus 10. The digital broadcasting receiving apparatus 10 includes an operating unit 11, a tuner 12, an ATSC interface (hereinafter referred to as ATSC IF) 13, an 8-VSB decoder 14, an IC 15, a RAM 16, a ROM 17, an EEPROM 18, a D/A converter unit 19, a sound signal output unit 20, a speaker 21, an NTSC encoder 22, a picture signal output unit 23, a display unit 24, and an MPU 25.

The operating unit 11 is made up of a plurality of keys for a user to do various operations such as a tuning operation. One of the keys is a channel up/down key 11a including a channel up key to be used for tuning in an ascending order of the channel number one by one channel and a channel down key to be used for tuning in a descending order of the channel number one by one channel. The selecting instruction of the channel up/down key 11a is based on virtual channels registered in a channel map that will be described later. Note that the operating unit 11 can be a remote controller using an infrared signal or the like for remote control.

The tuner 12 is connected to an antenna 30 for receiving digital broadcasting waves, and a desired channel is tuned from the digital broadcasting waves received by the antenna 30. The ATSC IF 13 extracts a digital output wave from the tuner 12. The 8-VSB decoder 14 decodes the digital output wave received from the ATSC IF 13 into data.

The IC 15 includes a TS demultiplexer 15a and an MPEG-2 decoder 15b. The TS demultiplexer 15a separates data decoded by the 8-VSB decoder 14 into data of individual types (VCT, EIT, picture data, sound data and the like). The MPEG-2 decoder 15b decodes the data separated by the TS demultiplexer 15a into data before compression.

The RAM 16 stores temporarily the data separated by the TS demultiplexer 15a. The ROM 17 stores information necessary for actions of the digital broadcasting receiving apparatus 10. The EEPROM 18 is one of the storage units and stores the channel map. This channel map is a list indicating at least an association between the virtual channel and the physical channel, which is generated by performing an automatic scan process or an automatic adding function that will be described later.

The D/A converter unit 19 converts the sound data delivered from the IC 15 into an analog signal. The sound signal output unit 20 outputs sound signal converted by the D/A converter unit 19 into an analog signal. The speaker 21 produces sounds base on the sound signal from the output unit 20.

The NTSC encoder 22 decodes the picture data decoded by the MPEG-2 decoder 15b into an NTSC decoded television signal. The picture signal output unit 23 outputs the NTSC decoded television signal decoded by the NTSC encoder 22. The display unit 24 displays pictures from the picture signal output unit 23 and is made up of a liquid crystal panel or the like.

The MPU 25 controls actions of the digital broadcasting receiving apparatus 10 and includes a comparing unit 25a, a registration control unit 25b and the like. The comparing unit 25a compares virtual channel information of the received physical channel (here, a virtual channel number included in the VCT) with the channel map. The registration control unit 25b controls rewrite of registered contents of the channel map, and it controls to register an unregistered virtual channel in the channel map, for instance.

Next, an action of the digital broadcasting receiving apparatus 10 when it receives digital broadcasting will be described. First, the antenna 30 receives the digital broadcasting wave. When the tuning operation of the operating unit 11 is performed, the tuner 12 changes a transponder to receive. A received digital broadcasting wave is decoded into data by the 8-VSB decoder 14 via the ATSC IF 13.

Originally, the digital broadcasting wave is sent in a form of TS packet from a transmission side. The TS packet is made up of picture data, sound data, and control data including the VCT and the like. This control data is separated by the TS demultiplexer 15a of the IC 15 and stored in the RAM 16. Then, the data read from the RAM 16 is decoded by the MPEG-2 decoder into data before compression. Next, the sound data is converted into an analog signal by the D/A converter unit 19, and the speaker 21 receives the analog signal via the sound signal output unit 20 and produces sounds. In addition, the picture data is decoded by the NTSC encoder 22 into the NTSC decoded television signal, which is sent via the picture signal output unit 23 to the display unit 24, which displays pictures.

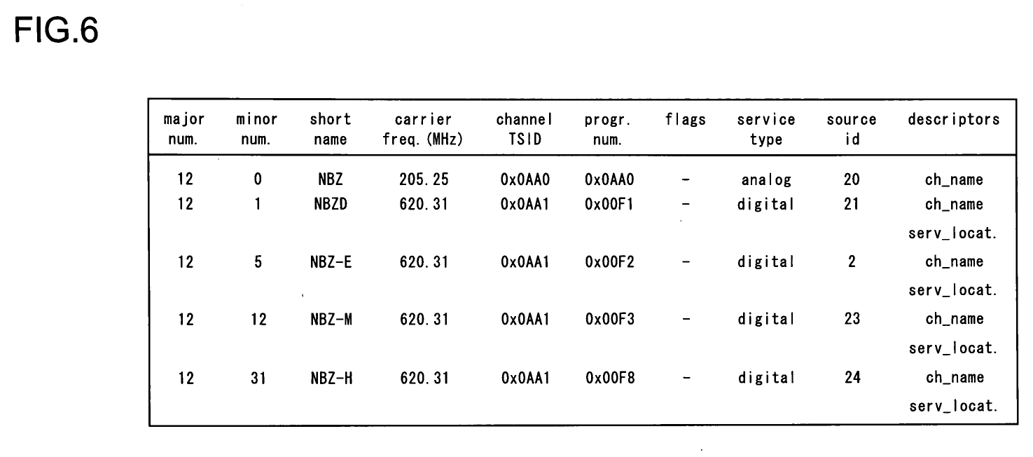

Furthermore, the tuning operation by the user is performed by inputting the virtual channel directly with a ten key (not shown) of the operating unit 11 or by operating the channel up/down key 11a. Here, the virtual channel includes a main channel and a sub channel. The major number shown in FIG. 6 corresponds to the main channel, and the minor number corresponds to the sub channel. Note that the virtual channel having the minor number of “0” is analog broadcasting in FIG. 6. Hereinafter, the main channel and the sub channel are separated by “-”. For instance, the case where the main channel is 12 and the sub channel is 34 is expressed as “12-34”.

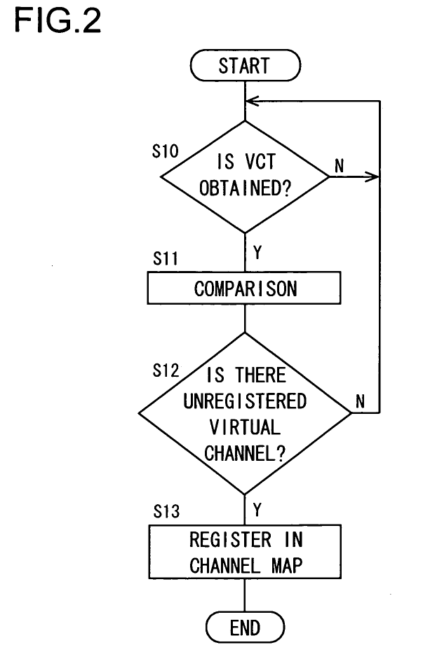

Next, the automatic adding function will be described, in which a new unregistered virtual channel is automatically registered in the channel map only by a normal tuning operation. FIG. 2 is a flowchart showing an action of the digital broadcasting receiving apparatus 10 about the automatic adding function.

First, when the MPU 25 obtains the VCT of the physical channel in step S10 after the tuning operation and the like, the comparing unit 25a compares the virtual channel number included in the VCT with the virtual channel number in the channel map in step S11. Then, if there is an unregistered virtual channel in the VCT in step S12, the registration control unit 25b registers additionally the physical channel corresponding to the virtual channel in the channel map in step S13. On the other hand, if there is no unregistered virtual channel in the step S12, the process goes back to the step S10.

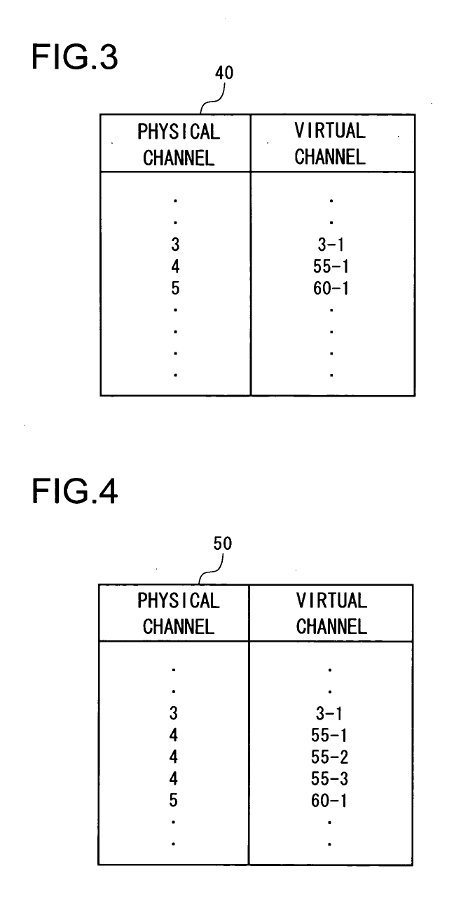

For instance, if the physical channel “4” is selected by the tuning operation during a period while a certain channel is being received, the VCT of the physical channel “4” is received. In this case, it is supposed that only the virtual channel of “55-1” corresponding to the physical channel “4” is registered in the current channel map 40 as shown in FIG. 3.

Then, the virtual channel numbers included in the VCT are extracted. It is supposed that the extracted virtual channel numbers are “55-1”, “55-2” and “55-3”, for instance. These three virtual channel numbers are compared with the virtual channels corresponding to the physical channel “4” in the channel map 40 shown in FIG. 3. As a result of the comparison, it is understood that the virtual channel number “55-1” extracted from the VCT is already registered in the channel map 40, and that the virtual channel numbers “55-2” and “55-3” extracted from the VCT are not registered yet in the channel map 40. Therefore, the unregistered virtual channels “55-2” and “55-3” are registered additionally in the channel map 40, and the channel map 40 is updated to be a channel map 50 shown in FIG. 4.

If the physical channel “4” is selected as the case described above, the broadcast program of the virtual channel “55-1” is display on the display unit 24 at that time. Since the channel map 40 is updated to be a channel map 50 soon after that, the virtual channels “55-2”, “55-3”, “60-1” . . . are selected in this order in accordance with the channel map 50 when the channel up key is operated in this state.

In this way, a new channel that is not registered yet in a channel map can be registered automatically only by a normal tuning operation. In addition, the new channel can also be selected by the channel up/down key. Therefore, the user is not required to do a special operation for registering in the channel map and to be conscious about registration in the channel map, so that very good usability can be realized.

Next, if there is a virtual channel number that is registered in the channel map but is not included in the received VCT, it may be left as it is, or the corresponding virtual channel number may be deleted from the channel map. For instance, it is possible to consider the case where the channel map 40 shown in FIG. 3 exists currently, and the virtual channel numbers included in the received VCT are “55-2” and “55-3”.

In this case, the virtual channel number “55-1” is left as it is if the product specification is as such. Then, the channel map 40 is updated to be a channel map 50 shown in FIG. 4. According to this specification, the virtual channel number that has been receivable at least once is retained and can be selected any time by using the channel up/down key 11a. However, the selected channel may be not broadcasting currently.

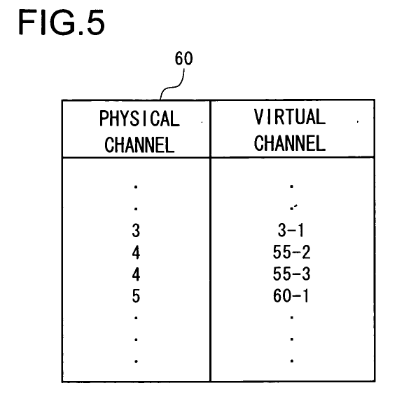

In contrast, if the product specification is to delete, the virtual channel number “55-1” is deleted so that the channel map 40 is updated to be a channel map 60 shown in FIG. 5. According to this specification, the virtual channel number that is not broadcasting currently is deleted from the channel map. Therefore, the channel that is not broadcasting currently cannot be selected when the channel up/down key 11a is used for tuning.

Note that the digital television or the like is described in the above embodiment, in which the digital broadcasting receiving apparatus 10 includes the speaker 21 and the display unit 24. However, the present invention can be applied to a set top box (STB) or a video apparatus as a tuner apparatus without the speaker 21 and the display unit 24.

Note that the digital broadcasting receiving apparatus of the present invention can be applied not only to the ATSC standard but also to other standard as long as it is a standard for delivering information such as the VCT including the virtual channel number.

The digital broadcasting receiving apparatus of the present invention can be utilized for a television receiving set such as a liquid crystal television as well as an STB as a tuner apparatus, a video cassette recorder, a DVD recorder or a hard disk recorder as a video apparatus, or a combination apparatus of them, a mobile phone with a digital broadcasting receiver function, or the like.

What is claimed is:

1. A digital broadcasting receiving apparatus comprising:
an operating unit for performing a tuning operation;
a storage unit for storing a channel map indicating an association between a virtual channel and a physical channel; and
a control unit for obtaining virtual channel information multiplexed in the physical channel that is currently received, wherein
when the tuning operation of the operating unit is performed, the control unit compares the virtual channel information of the received physical channel with the channel map and registers a virtual channel in the channel map if the virtual channel is not registered yet in the channel map.

2. The digital broadcasting receiving apparatus according to claim 1, wherein the control unit includes a comparing unit for comparing the virtual channel information of the received physical channel with the channel map, and a registration control unit for controlling to register a virtual channel in the channel map if the virtual channel is not registered yet in the channel map.

3. The digital broadcasting receiving apparatus according to claim 1, wherein the operating unit has a channel up/down key to be used for the tuning operation, and an instruction of the channel up/down key is based on the channel map.

4. The digital broadcasting receiving apparatus according to claim 1, wherein the virtual channel information is included in VCT (Virtual Channel Table) of ATSC (Advanced Television System Committee) broadcasting.

5. The digital broadcasting receiving apparatus according to claim 1, wherein the control unit controls to compare the virtual channel information of the received physical channel with the channel map and to remove a virtual channel from the channel map if the virtual channel is registered in the channel map but is not included in the received virtual channel information.

6. The digital broadcasting receiving apparatus according to claim 1, wherein the control unit is an MPU, the storage unit is an EEPROM, and the digital broadcasting receiving apparatus further includes a display unit for outputting received pictured and a speaker for outputting received sounds.
